(19) United States
(12) Patent Application Publication
(10) Pub. No.: US 2026/0200694 A1
(43) Pub. Date: Jul. 16, 2026

(54) MANIPULATOR ROBOT FOR THE MOVEMENT OF YARN BOBBINS FOR TEXTURING MACHINES

(71) Applicant: IRICO GUALCHIERANI HANDLING S.R.L., Firenze (IT)

(72) Inventors: Niccolo' PAOLI, Prato (IT); Luca LACITIGNOLA, Prato (IT)

(73) Assignee: IRICO GUALCHIERANI HANDLING S.R.L., Firenze (IT)

(21) Appl. No.: 19/133,731

(22) PCT Filed: Dec. 1, 2023
(86) PCT No.: PCT/IB2023/062125

§ 371 Date: May 29, 2025

(30) Foreign Application Priority Data
Dec. 7, 2022 (IT) 102022000025182

(51) Int. Cl. B65H 67/06; B25J 5/00; B25J 5/04; B25J 9/16; B65G 1/137; G05D 1/222

(52) U.S. Cl. CPC B65H 67/065; B25J 5/007; B25J 5/04; B25J 9/1697; B65G 1/1371; G05D 1/222; B65H 2701/31

(57) ABSTRACT

A manipulator robot for the movement of bobbins (B) of yarn wound on a tube, intended for feeding a creel (C) of texturizing machines comprising a vehicle AGV carrying on board a bobbin magazine installed on board and provided with vertical guides for a manipulator device provided with a gripping member to transfer one or more bobbins, or empty tubes, between a creel and the on-board magazine.

### CROSS REFERENCE TO RELATED APPLICATIONS

This application is a national stage entry of International Application No. PCT/IB2023/062125, filed on Dec. 1, 2023, which is based upon and claims foreign priority to Italy Patent Application No. 102022000025182, filed on Dec. 7, 2022, the entire contents of which are incorporated herein by reference.

### TECHNICAL FIELD

The invention concerns a collaborative robotic system for the movement and the loading/unloading of bobbins of yarns, for example pre-oriented yarns of synthetic yarn (such as POY yarn) for feeding creels of texturizing machines.

### BACKGROUND

It is known in particular that the pre-oriented polyester (POY) yarns are the starting material for the production of synthetic yarns of a wide range of fashion, sports, functional and home fabrics.

POY is a partially oriented yarn that is produced by melting and extrusion (melt spinning) of the polyester chip or flake subsequently subjected to texturizing to increase the volume and elasticity of the filament fibres.

To maximise the productivity of the texturizing machines, bobbins of considerable sizes (about 15 kg each and even more) of POY yarn wound around a core called a tube are used in input, and each machine, at present, is generally provided with a double working front and up to 350-380 production heads of bobbins of textured thread (DTY).

In production, each head is fed by two POY bobbins placed on special creels that house the tubes of the bobbins of which one is being processed while the other is waiting for the thread on the bobbin being fed to end. To give continuity to the process, the final end of the first bobbin is tied with the initial end of the second and when the thread of the bobbin being processed ends, the one waiting starts unwinding without interruptions.

Each POY bobbin has a working life on the creel that can reach about 24 hours and beyond depending on the yarn to be processed; since each production plant has several texturizing machines, numerous bobbin replenishments are required per working shift. For example, assuming a plant with ten machines, there will be about 7,600 bobbins on creels, 3,800 being processed and 3,800 waiting.

When replenishing the bobbins, the operator must carry out a series of operations, namely:
By acting on a lever of the bobbin support, he or she rotates the empty tube outwards to facilitate the extraction thereof
He or she removes the plastic disc whose head may be mounted on the tube, which prevents the unwinding thread from getting caught in the tube,
He or she pulls out the empty tube,
He or she inserts the new bobbin,
He or she inserts the disc on the head side,
He or she ties the tail of the thread of the bobbin being worked, with the head of the thread of the waiting bobbin,
He or she brings the bobbin back into position by turning the support lever.

The work of the operators is therefore highly demanding both due to the weight of the bobbins to be moved and due to the continuous walk for watching necessary for checking on the bobbins that must be replenished.

For this reason, although the need to automate the management of the bobbins in the creels in the texturizing machines dates back many years, this step has been substantially excluded by the progressive introduction of automation in the processings, due to the high costs linked with the movement and replenishment of the bobbins on the creels.

More recently, the technical progress in the field of automated guided vehicles has led to the availability of devices with articulated arm robots and AGVs (Automated Guided Vehicles) that are now widely used in the assembly lines and where frequent movement of objects is necessary.

AGVs are in fact robotic automated guided vehicles that move without human intervention along a path, for example, following markers, magnets or wires in the floor or using a navigation system, for example, a vision or laser or natural navigation system comprising sensors that detect the surrounding environment.

However, it is known in the sector that while the robots and the vehicles AGV currently used are satisfactory as to the transport and handling of lightweight objects and with little outreach, they do not have the load and stability characteristics necessary for the movement of the POY bobbins to the required heights (almost two meters high), with the consequence that the creel management step still remains an exclusive task of the operators who have yet to guarantee a continuous watching and manually carry out the replenishment of the empty bobbins.

From CN113247704 an automatic feeding equipment for bobbins of POY yarn is for example known which comprises a movable vehicle AGV and a collaborative robot installed on the movable vehicle which is provided with an anthropomorphic arm with a terminal gripping element, or spindle, for unloading bobbins and loading empty tubes from and to respective magazines mounted on board the vehicle.

However, the collaborative robots of known type have limits due to the amplitude of the overhang between the point of attachment of the manipulator or of the anthropomorphic arm and the point of loading/unloading of the bobbins, which limits the manageable load, and the overall size that makes it difficult to use the robot to also serve pairs of opposing creels arranged in rows on both sides of the robot, i.e. when it is desirable to have a greater number of bobbins available on board the vehicle.

The need is therefore felt for a robotic system (which is capable of transferring a large number of bobbins carried on board the vehicle and adequate to reduce the tasks of high physical wear of the operators and which therefore allows operators to engage in activities with greater intellectual commitment with a gain in physical and mental health.

The present invention therefore aims to overcome the drawbacks of the solutions already known and to propose an automated guided robot (AGV) to automatically manage the filling of the creels of the texturizing machines with POY bobbins or of other types of machines such as twisters, heat-setting or frame creels with yarn bobbins in the necessary shapes and materials, which is reliable and flexible and helps operators to carry out repetitive and tiring tasks and which are able to interface with existing creels of various manufacturers.

This device can also be used for the automatic lifting of the POY, FDY, DTY, HTY, BCF and similar synthetic spinning machines.

### SUMMARY

These purposes have been achieved by realizing a collaborative robot according to at least one of the appended claims, comprising a vehicle AGV carrying on board a bobbin magazine provided with guides for the vertical movement of a manipulator device provided with a gripping member to transfer one or more bobbins, and/or empty tubes, between a creel and the on-board magazine.

A first advantage consists in improving the quality of the working conditions of the staff, increasing productivity in the replenishment and replacement of the bobbins and a drastic reduction in errors.

A second advantage consists in the reduction in the number of trips for bobbin supply by the operator.

A further advantage derives from the need to no longer watch the machines if a sensor is installed, an optional but integral part of this patent, which determines the successful passage of the thread from the bobbin being worked to the bobbin in the reserve. This sensor would be connected to the creel management information system that would direct the operator at the right time and in the right position to carry out manual operations and at the same time a POY bobbin loading list would be formed that would allow the optimization of the routes of the vehicles AGV.

A further advantage consists in the reduction of accidents at work due to the bobbin replenishment operation.

A still further advantage of the invention consists in that the bobbins maintain a high quality since their outer surface will not be touched during the handling of the bobbin itself.

A further advantage consists in that it is possible to automatically trace the load of the bobbins and then determine which product was being processed on the machine in that position and for which period of time with important implications for the quality of the final product.

A further advantage allows, by combining the automatic loading of the robot with the sensor that automatically determines the successful passage, to know in which bobbin of DTY thread produced there is the junction between the two POY bobbins consecutively used on the creel for feeding the machine.

### BRIEF DESCRIPTION OF THE DRAWINGS

These and other advantages will be better understood by any person skilled in the art from the following description and the accompanying drawings, given as a non-limiting example, in which:

FIG. 1 shows a first embodiment of the robot of the invention, in perspective view;

FIG. 1a shows a second perspective view of the robot of FIG. 1 with bobbins mounted in the on-board magazine;

FIG. 1b shows a bottom view of the robot of FIG. 1;

FIG. 2 shows a side view of the robot of FIG. 1 when picking up a bobbin from an external transport device with a bobbin rack; this device may also be a trolley with wheels;

FIG. 2a shows a detail of section A-A of FIG. 2 with the bobbin gripping mechanism highlighted;

FIG. 3 shows the gripping device of the robot of FIG. 1 in frontally expanded configuration and with the axes of freedom of the permitted movements indicated;

FIG. 3a shows the device of FIG. 3 in contracted configuration;

FIG. 3b shows the device of FIG. 3 in lateral expanded configuration;

FIG. 3c shows the device of FIG. 3 in posteriorly expanded configuration;

FIG. 4 shows the device of FIG. 3 in side view in frontally expanded configuration;

FIG. 4a shows a detail of FIG. 4 in section seen from above with the movement mechanism of the first axis of freedom Al highlighted;

FIG. 5 shows a detail of the transmission along the second axis of freedom A2 of the linear movement device of FIG. 3;

FIG. 6 shows a rear view of the device of FIG. 4 with parts removed to highlight the motion transmission elements of the third and fourth axis of freedom;

FIG. 6a shows a side view of the device of FIG. 6;

FIG. 7 shows a detail of the device of FIG. 4 with a movement according to the fourth axis of freedom highlighted;

FIG. 8 shows a second embodiment of the robot of the invention in rest configuration;

FIG. 8a shows a side view of the robot of FIG. 8 in operating configuration with bobbins mounted in the on-board magazine;

FIG. 8b shows a front view of the robot of FIG. 8;

FIG. 9 shows a robot according to the invention with a remote control station;

FIG. 10 shows a further preferred embodiment of the invention;

FIGS. 11a, 11b show schematically an elevation view and a top view of a rotating creel usable in combination with the robot of the invention.

### DETAILED DESCRIPTION OF THE EMBODIMENTS

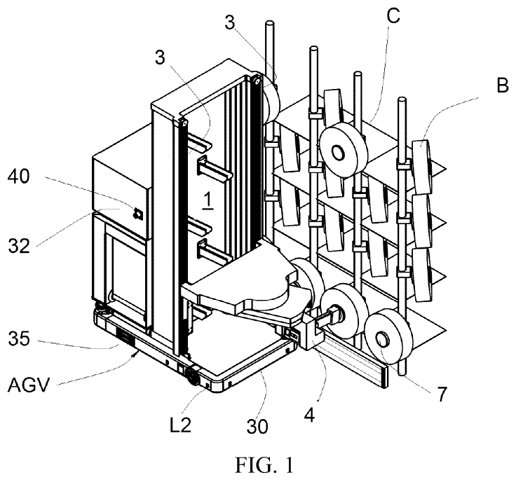

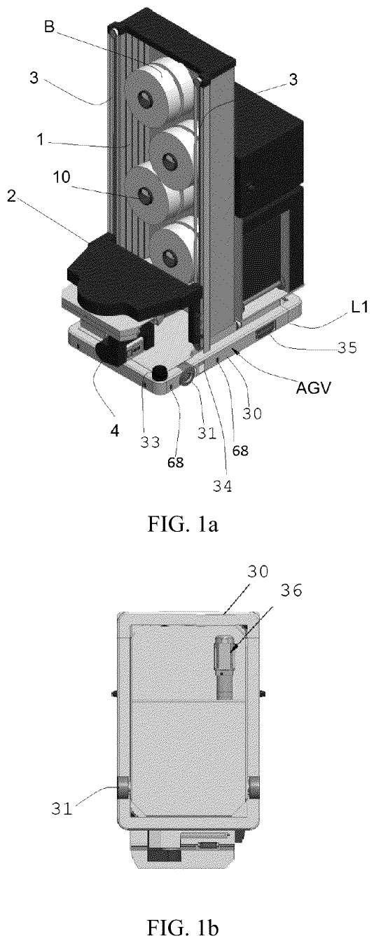

With reference to the attached drawings, there is described a robot according to the invention for the movement of yarn bobbins B intended for feeding a creel C (in several points the creel C of FIG. 1 is mentioned but in reality that figure refers to the picking of the bobbins from racks IGH. I am sending you in attachment the correct drawing) of texturizing machines (FIG. 1).

The robot comprises an automated guided vehicle AGV formed by a base 30 movable on wheels 31, on which a column 1 provided with linear guides 3 is mounted in elevation and configured to constitute an on-board magazine 1 for the bobbins B, insertable into special housings, for example pegs 8 of dimensions suitable for housing the bobbins B and/or the bobbin winding tubes 5.

Preferably, the vehicle AGV is a self-driving electric vehicle provided with motion parts and rechargeable batteries which are housed in a compartment 32 and powered by power supply contacts 35.

The AGV may also be provided with navigation sensors 33, sensors 68 for aid in verifying the alignment and position of the vehicle during the displacement, lateral safety sensors 40 for collision risk and reading devices, for example, barcode scanners 34 for reading codes associated with the intervention and bobbin transfer station, positioned at the creel C. It may also be provided with scan grid type safety sensors during the creel loading step.

It is understood that the vehicle AGV may comprise any function useful for a fully autonomous operation and remote supervision of the displacements and transfer operations of the bobbins, (remote driving, position control, collision risk control), but may also be managed with manual driving systems.

In the example described, the linear guides 3 are formed by a pair of prismatic guides integral with the magazine 1 arranged in elevation with respect to the base 30 and horizontally spaced widthwise, i.e. between the sides L1, L2 opposite with respect to the direction of advancement D of the vehicle (FIG. 1).

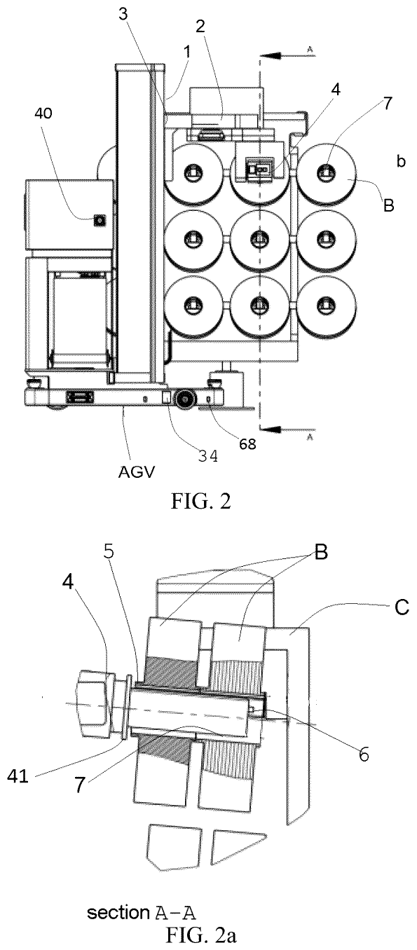

According to the invention, a manipulator device 2 is vertically movable on the guides 3, which is provided with a gripping member 4 (FIG. 2a) configured to take and transfer at least one bobbin B and/or one tube 5 between a housing, for example pegs 7 of a creel C and a housing, for example pegs 8, of the on-board magazine 1.

In a preferred embodiment, the gripping member 4 may comprise a camera 6 to guide the precise positioning of the bobbins and/or tubes. For safety purposes, this device is provided with a sensor 10 to avoid any crushing.

By way of example, the manipulator 2 is movable thanks to a lifting mechanism 36 housed in the base 30 of the vehicle and controllable to give the manipulator 2 an up and down movement along an axis A5 parallel to the guides 3 for example by means of a belt linkage.

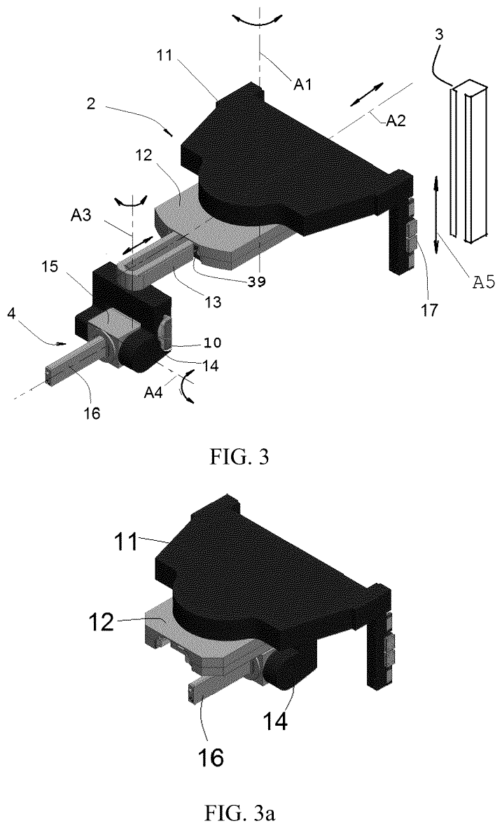

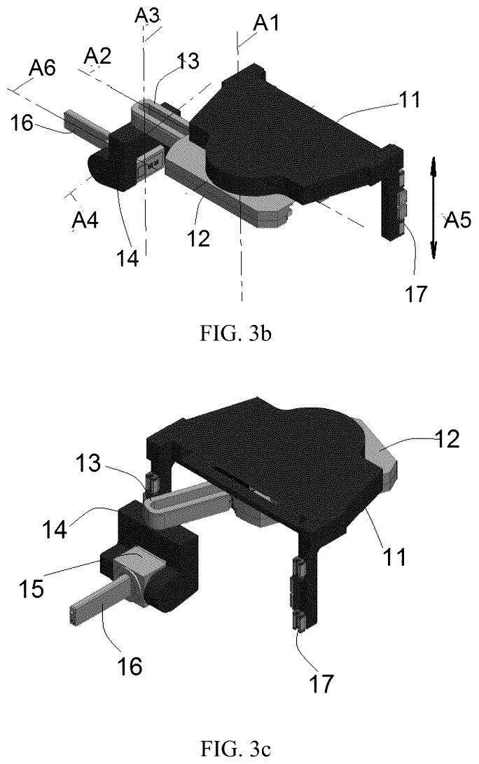

With reference to FIGS. 3 and 3a-3c, a first embodiment of the manipulator device 2 comprising a plurality of components mutually bound around three independent axes of rotation A1, A3, A4, and along two independent translation axes A2, A5.

More in detail (FIG. 3, 3a-3c), the manipulator device 2 comprises
a first support 11 movable along the axis A5 of the linear guides 3 by means of guide elements 17, for example sliding skids connected to the servomotor lifter 36.
a plate 12 rotatably bound to the support 11 by at least 180° about an axis of rotation A1,
a rod 13 slidable along a second translation axis A2 with respect to the plate 12, for example inside a channel 39 of the plate 12,
a rotating support 14 carried by the rod 13, rotating by 360° around an axis of rotation A3 parallel to the axis A1,
a gripping member 4 comprising a block 15 rotating about an axis of rotation A4 with respect to the second support 14 and a pin or gripping peg 16 of axis A6, protruding from the block 15.

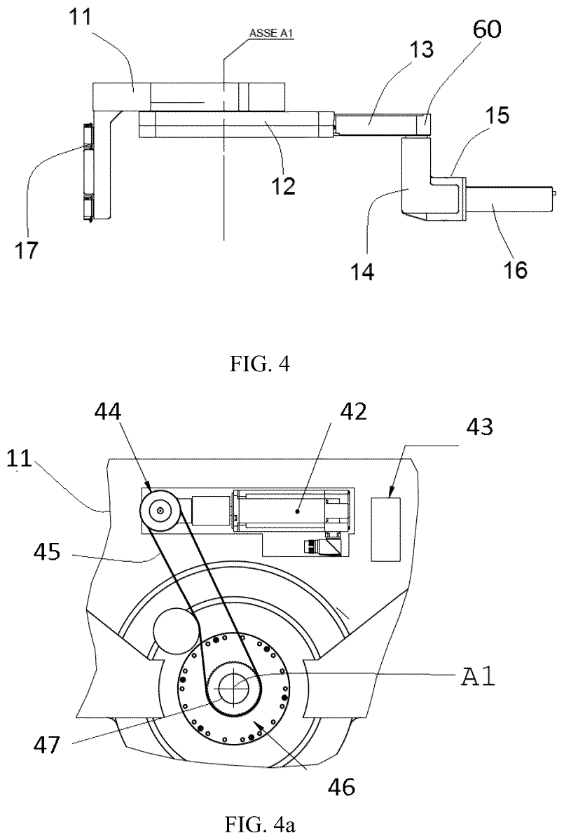

The movement of the manipulator 2 can be obtained with different mechanical solutions. In the example described, to be understood in a non-limiting sense:
the rotation of the plate 12 around the axis A1 is obtained by means of (FIG. 4a) a servomotor 42 controlled by a drive 43 to rotate a pulley 44 connected by means of a belt 45 to a reducer 46 integral with a shaft 47 of axis A1 of the plate 12.

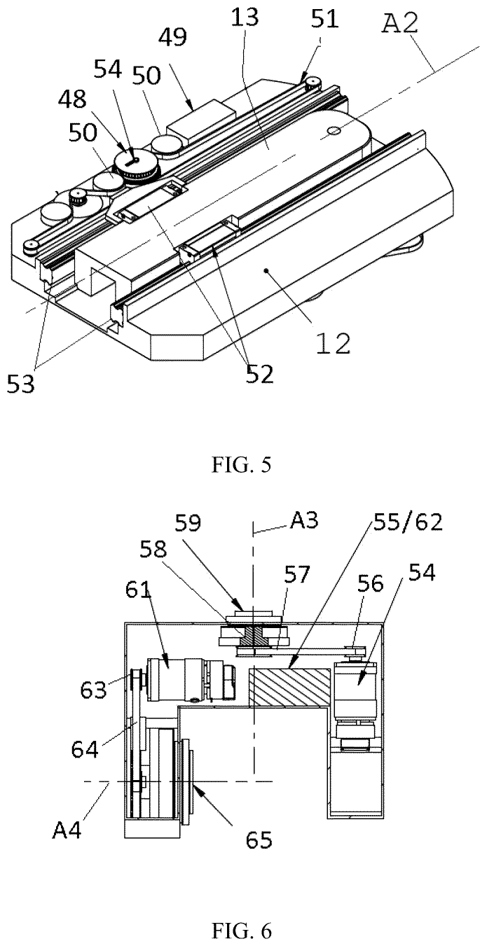

The translation of the rod 13 along the axis A2 is obtained by means of a linkage housed in the plate 12 (FIG. 5) comprising a servo-actuator 48, preferably with magnetic encoder 54, controlled by a drive 49 to rotate a belt 51 subtended by pulleys 50 and connected to one of a pair of recirculating skids 52 integral with two sides of the rod 13 and slidable on respective prismatic guides 53 of axes a2 fixed to the plate 12;

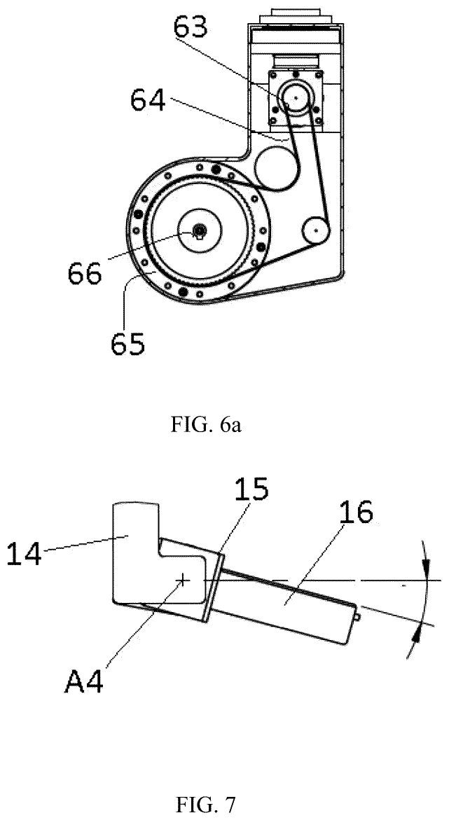

The rotation of the support 14 around the axis A3 (FIG. 6) is obtained by means of a linkage housed in the support 14 and comprising a servomotor 54 controlled by a drive 55 to rotate a pulley 56 connected by means of a belt 57 to a reducer 58 integral with a shaft 59 of axis A3 that connects the support 14 to the free end 60 of the rod 13.

The rotation of the block 15 around the axis A4 is obtained (FIGS. 6, 6a) by means of a second linkage housed in the support 14 and comprising a servomotor 61 controlled by a drive 62 to rotate a pulley 63 connected by means of a belt 64 to a reducer 65 integral with a shaft 66 of axis A4 integral with the block 15;
along the axis A6 there is a thrust movement of the bobbins.

Advantageously, with the illustrated solution, the manipulator can work in restricted and narrow environments unlike an anthropomorphic robot.

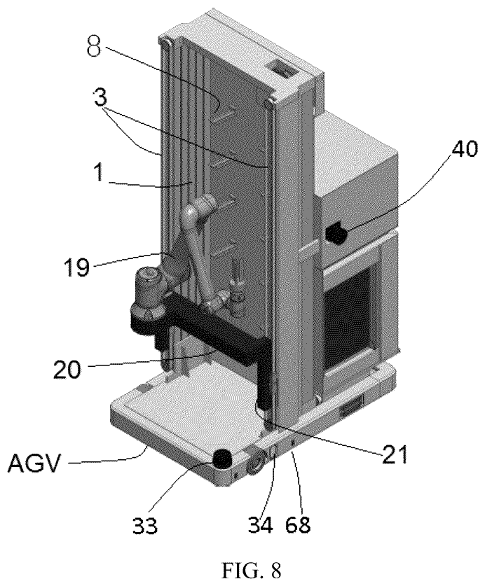

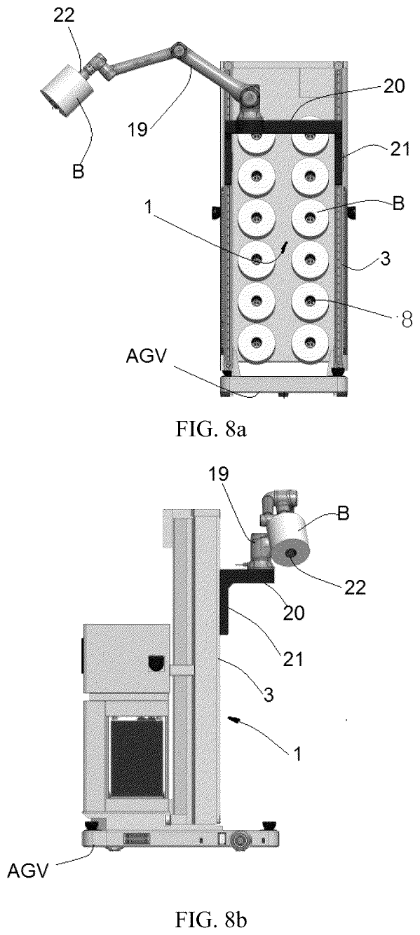

With reference to FIGS. 8 and 8a-8b, a second embodiment of the manipulator device is described, comprising an anthropomorphic arm 19 provided at the free end with a gripping member 4 of the bobbins B.

Also in this case the manipulator device 20 is slidable along the axis A5 of the guides 3 and the arm 19 is slidably mounted along a cross member 20 extended between said opposite sides L1, L2 of the vehicle and which can move on the linear guides 3 by means of guide elements 21, for example sliding skids.

Advantageously, with this solution, the arm 19 can displace transversely and operate with a reduced overhang by manoeuvring the gripping member 22 between the on-board magazine 1 and the creels C arranged adjacent to the opposite sides L1, L2 of the vehicle, thus being able to handle high weight bobbins.

In operation, the manipulator robot of the invention is able to perform some operations to support the operator, in order to reduce the effort and physical risks required of the operator by reducing human intervention in the operating cycle.

In particular, in an example of operation of the robot, the replenishment of the bobbins B to the creel C will be implemented with this sequence of steps:
The operator, while watching, identifies an empty tube 5 on the creel and calls the robot to intervene, for example through the WIFI barcode reader 34 or another system that communicates the position of the empty bobbin to the robot;
The operator manually rotates the lever that in the creels generally operates the support 7 of the bobbin and manually pulls out the head disc 41 that is placed to block the bobbins, and the empty tube 5;
The robot, thanks to the navigation system, autonomously reaches the intervention position read by the reader 34;
The robot automatically inserts the bobbin into the support 7 of the creel by picking it up from the supports 8 of the on-board magazine 1;
The operator inserts the head disc;
The operator ties the terminals of the head-tail threads between the two bobbins;
The operator rotates the bobbin support again into the working position.

In a further example of use, the call of the robot to intervene can take place automatically, for example thanks to the use of a sensor arranged near the bobbins on the creel C, for example an optical sensor that detects the presence or not of the thread that ties the tail with the head and hence the need to replenish the creel will be communicated wirelessly to the robot together with the position coordinates.

In this case, the robot will be able to perform the following operations:
reaches the intervention position autonomously;
rotates the bobbin support lever;
pulls out the head disc and the empty tube
automatically inserts the bobbin by picking it up from the on-board magazine;
while the operator only has to insert the head disc and tie the terminals of the head-tail threads between the two bobbins on the creel, finally rotating the bobbin support into the working position.

Advantageously, in this case the use of the robot will also positively affect the intervention times as it does not require the call by the operator in addition to speeding up the individual activities compared to manual execution.

The invention entails significant advantages, since the extraction of the tube and positioning of the new bobbin is made automatically and the need for human watching of the creel is eliminated.

In addition, the operator will no longer have to equip him-herself with a trolley to transport the bobbins housed in the on-board magazine and the robot will be able to go autonomously to a special refilling area to fill the on-board bobbin magazine using the manipulator.

In a preferred embodiment, the possibility of remote control of the robot will also be provided, which must allow at least:
Real-time detection of the positioning of the robot,
Verification/modification of the working speeds
The reading of the work log as a report of the interventions made and any problems detected
Scheduled maintenance management
The display of the battery charge level
The status of the on-board bobbin magazine.

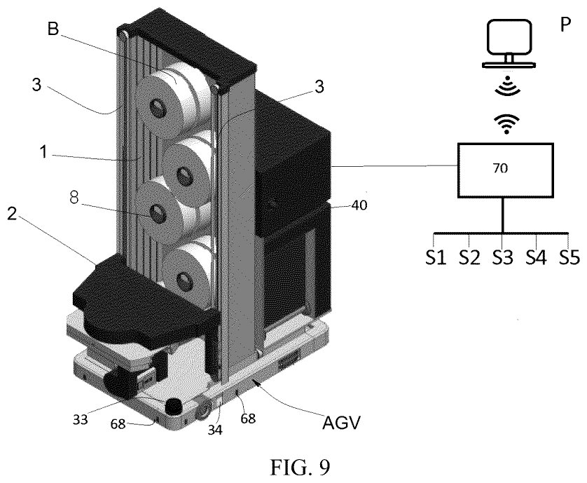

In this case, the control can be done from a remote control station P, schematized in FIG. 9, connected wirelessly to a remote control interface 70 of the robot operatively connected at least
to position sensors S1 for the detection of the position, displacements, speed and parking times, including for example navigation sensors 33,
to an archive S2 of the work log,
to movement and maintenance management software S3,
to battery charge indicators S4, and
to indicators S5 of the number of bobbins in the on-board magazine.

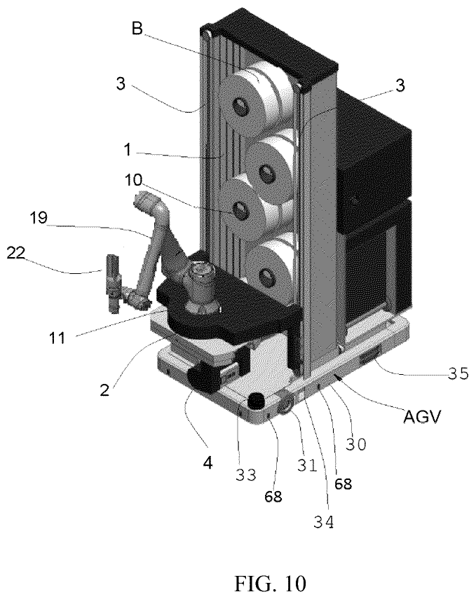

With reference to FIG. 10, a preferred embodiment of the invention is described, in which the manipulator robot comprises an automated guided vehicle AGV of the type described above, equipped with linear guides 3 on which both a first manipulator device 2 and a second manipulator device 19 can slide.

According to the invention the two manipulators are controlled to perform complementary operations, which are at least in part distinct, comprising at least the operations of loading unloading the full bobbins and the empty tubes from and to the creel and an external magazine and the operations of orientation and preparation of the pegs 7 of the creel that must be performed prior to the operations of loading the bobbins on the pegs 7 and of unloading the tubes from the creel.

By way of example, the first manipulator is a manipulator 2 of the type already described with reference in particular to FIGS. 3-7 and is provided with a gripping member 4 configured to take and transfer at least one bobbin B and/or one tube 5 between a housing 7 of a creel and a housing 10 of the on-board magazine 1, while the second manipulator comprises an anthropomorphic arm 19, of the collaborative type or not, of the type described with reference to FIGS. 8, 8a-8b provided at the free end with a device, for example a gripper or a pin 22 adapted to handle the tubes or to intervene on the creel and also slidable along the same linear guides 3.

Preferably, the second manipulator 19 is mounted on an upper support 11 of the first manipulator 2, but it is understood that it can be otherwise bound to the first manipulator 2 or even be independent thereof while sliding along the same guides 3.

Furthermore preferably, also in this embodiment, the robot can envisage a magazine for bobbins 1 installed on board the vehicle AGV to which the linear guides 3 are integral.

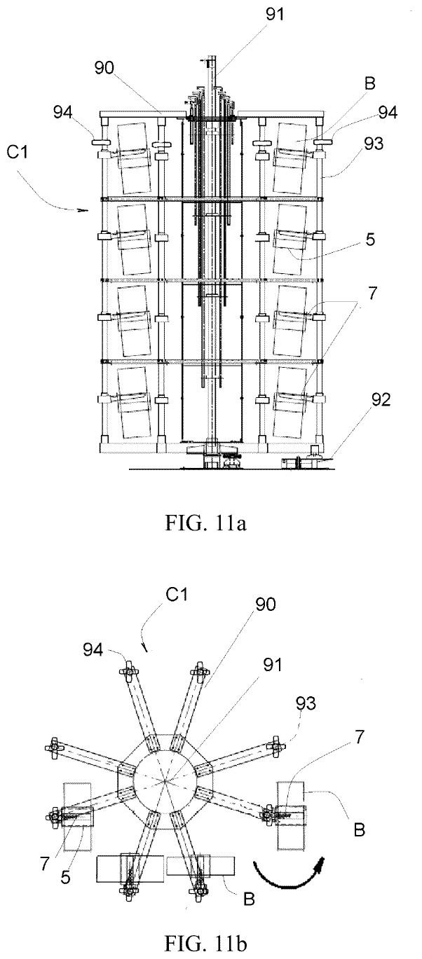

In an example of application, the robot is associated in use with a rotating creel C1, of the type per se known schematized in FIGS. 11a, 11b, provided with a frame 90 with rotating uprights 93 carrying the supports 7 of the bobbins B, for example of the pegs of the type described above, on which the full bobbins must be loaded and the empty tubes 5 unloaded, with the frame 90 that can rotate around a central axis 91 to show on the side occupied by the robot one or more supports 93 to be able to perform the loading and unloading operations and remain blocked in position for example by means of a rotation blocking device 92 placed at the base of the frame 90, this also being of per se known type.

In this case, advantageously, the presence of two manipulators dedicated to distinct operations makes it possible to optimally manage not only the operations of loading and unloading the bobbins and preparing the supports of the creel, but also the operations of rotating the frame 90 and/or of blocking/unblocking it in the desired loading, unloading position of the bobbins.

By way of example, in a preferred way of application of the invention, the manipulators 2 and 19 will be able to perform the following operations.

The manipulator 2 performs the operations of unblocking the rotating creel by intervening, for example, by means of the pin 16 on the creel blocking device 92 visible in FIG. 11a;
once the creel has been unblocked, the upper manipulator 19 can engage the frame 10 by means of the gripping member 22, and rotate the frame of the creel until the creel is brought into the position for unloading an empty tube of a bobbin to be replaced. By way of example, this operation may be performed with the manipulator 19 acting on the upright 93 itself or on a movement member, for example a cross element 94 rotatably integral with the uprights 93;
in this position, the lower manipulator 2 again blocks the creel by acting on the blocking device 92 and then the upper manipulator 19 rotates the pin 7 of the supporting creel C1 with the tube into the loading/unloading configuration, as shown on the right in FIG. 11b;
subsequently, the upper manipulator 19, or alternatively the lower manipulator 2, can remove the empty tube 5 and stow it in an external magazine;
at this point, the lower manipulator 2 picks up a full bobbin from the external magazine, in the case described, the on-board magazine 1, and places it on the peg 7 of the creel;
now the upper manipulator 19 can rotate the pin 7 back into the working position with the full bobbin.

With the solution adopted, by differentiating the functions of the manipulators 2, 19 significant advantages are obtained in particular due to the fact that the upper manipulator 19, whose function is essentially to rotate the creel and the relative pegs, is a robot that can be modified and/or programmed as a function of the various types of available creels, regardless of all the rest and in particular of the type of lower manipulator adopted.

The invention has been described with reference to a preferred embodiment, but it is understood that equivalent modifications may be made without in any case departing from the scope of protection granted to this industrial patent.

What is claimed is:

1. A manipulator robot for the movement of one or more bobbins of yarn wound on a tube intended for feeding one or more creels of texturizing machines comprising:
an automated guided vehicle,
an on-board magazine for bobbins installed on board the automated guided vehicle and provided with linear guides,
a manipulator device movable on the guides and provided with a gripping member configured to take and transfer at least one bobbin and/or one tube between a housing of a creel and a housing of the on-board magazine,
wherein the linear guides are integral with the on-board magazine.

2. The manipulator robot according to claim 1, wherein the on-board magazine is a vertical magazine mounted in elevation on a base of the automated guided vehicle and the guides are vertical guides integral with the on-board magazine.

3. The manipulator robot according to claim 1, wherein the manipulator device is a device with at least four degrees of freedom comprising a plurality of components mutually bound around at least three independent axes of rotation and along at least two independent translation axes.

4. The manipulator robot according to claim 3, wherein the manipulator device comprises:
a first support slidable by means of guide elements along a translation axis parallel to the linear guides,
a plate rotating by at least 180° around a first axis of rotation,
a rod slidable along a second axis of translation with respect to the plate,
a second support carried by the rod rotating by 360° around a second axis of rotation with respect to the rod,
a gripping member comprising a block rotating about a third axis of rotation with respect to the second support and a gripping pin protruding from the block.

5. The manipulator robot according to claim 1, wherein the manipulator device comprises a collaborative or non-collaborative type anthropomorphic arm provided at the free end of the gripping member of the bobbins and/or tubes.

6. The manipulator robot according to claim 5, wherein said the collaborative or non-collaborative type anthropomorphic arm is slidable along a cross member mounted by means of guide elements on the linear guides and extended between opposite sides of the automated guided vehicle.

7. The manipulator robot according to claim 4, wherein the gripping member is maneuverable so as to be able to take and transfer the bobbins and/or the tubes between the on-board magazine and at least two creels arranged adjacent to opposite sides of the automated guided vehicle.

8. The manipulator robot according to one claim 1, wherein the on-board magazine comprises a distribution of housings to receive the empty tubes of the bobbins unloaded by a creel.

9. The manipulator robot according to claim 1, provided with a camera configured to guide a precise positioning of the bobbins and/or tubes.

10. The manipulator robot according to claim 1, wherein the automated guided vehicle is provided with a code reader configured to verify a transfer position of the bobbins and/or tubes by reading codes associated with the transfer position from and to a creel.

11. The manipulator robot according to claim 1, wherein the automated guided vehicle is provided with an autonomous navigation system, comprising at least navigation sensors.

12. The manipulator robot according to claim 1, wherein the automated guided vehicle is provided with a wireless communication interface with a remote control station.

13. The manipulator robot according to one claim 1, wherein the automated guided vehicle is provided with sensors for verifying the alignment and position of the automated guided vehicle, and of lateral safety sensors for collision risk.

14. The manipulator robot according to claim 1, wherein the automated guided vehicle is provided with an interface with a monitoring system of a sensors placed on the creels that verify the changeover of the bobbin during work.

15. The manipulator robot according to claim 1, wherein the automated guided vehicle is provided with linear guides on which both a first manipulator device and a second manipulator device can slide.
